(19) United States
(12) Patent Application Publication
(10) Pub. No.: US 2010/0137030 A1
(43) Pub. Date: Jun. 3, 2010

(54) FILTERING A LIST OF AUDIBLE ITEMS

(75) Inventor: Changxue Ma, Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/326,475

(22) Filed: Dec. 2, 2008

(51) Int. Cl. H04M 1/00; G10L 21/00; G09G 5/00

(52) U.S. Cl. 455/563; 704/278; 704/275; 345/619; 455/550.1; 455/566

(57) ABSTRACT

Disclosed is a technique for presenting audible items to a user in a manner that allows the user to easily distinguish them and to select from among them. A number of audible items are rendered simultaneously to the user. To prevent the sounds from blending together into a sonic mishmash, some of the items are “conditioned” while they are being rendered. For example, one audible item might be rendered more quietly than another, or one item can be moved up in register compared with another. Some embodiments combine audible conditioning with visual avatars portrayed on, for example, a display screen of a user device. During the rendering, each audible item is paired with an avatar, the pairing based on some suitable criterion, such as a type of conditioning applied to the audible item. Audible spatial placement is mimicked by visual placement of the avatars on the user's display screen.

### FIELD OF THE INVENTION

The present invention is related generally to computer-mediated search tools and, more particularly, to searching through a list of audible items.

### BACKGROUND OF THE INVENTION

So much information is now available on-line that users are often faced with the problem not of accessing what they want, but with identifying what they want within a huge list of possibilities. For example, on-line searches can return so many “hits,” that they overwhelm the user and become essentially useless. To address this information overload, search engines are becoming more intelligent and more selective in what they present. Popular search engines, for example, organize the hits they return by popularity or by some other recognized measure of quality (including revenue paid to the search engine provider by the sponsor of a hit), putting the “best” hits nearer the top so that users can focus on the hits with the greatest potential relevance.

In other developments, user interfaces are becoming very sophisticated in how they present a list of multiple items to a user. Rather than producing a simple ordered list, these interfaces take advantage of the human brain's enormous visual processing capacity by creating and presenting ornate “pictographs” that represent items on the list and the relationships among them with color highlighting, connecting lines, and virtual three-dimensional placement. The user can quickly grasp not only which items are ranked the “best” (by whatever criteria), but also how much “better” those items are than others, why they were ranked better, and what other alternatives exist.

These techniques of ranking items on a list and of presenting them visually have been applied for the most part to text-based items. More primitive, but still partially successful, are interfaces that attempt to apply these techniques to visual items, such as still images or even video clips. However, these systems are in fact usually hybrids, because their ranking and organization are usually based on textual metadata attached to the visual images.

Even more primitive than the visual user interfaces are interfaces developed for presenting audible items. Because the human brain is much less adept at processing audio samples than at processing visual samples, few if any interfaces have been shown that are very useful in helping a user search through a list of audible items.

### BRIEF SUMMARY

The above considerations, and others, are addressed by the present invention, which can be understood by referring to the specification, drawings, and claims. According to aspects of the present invention, audible items from a list of such items are presented to a user in a manner that allows the user to easily distinguish them and to select from among them.

According to one embodiment, a number (at least two) of audible items are rendered (e.g., played through headphones or speakers) simultaneously to the user. To prevent the sounds from blending together into a sonic mishmash, some of the items are “conditioned” while they are being rendered. For example, one audible item might be rendered more quietly than another, or one item can be moved up in register compared with another. Also, the human brain's audio placement capabilities can be brought into play by subtly altering the dynamics of rendering the items so that one item seems to come from farther away than another item, or some items can be perceived as coming from the hearer's right side and some from the left. While the human brain's audio spatial capabilities are limited, experiments have been shown that these placement techniques can be used while simultaneously rendering up to four audible items, and a user can reliably distinguish among the four.

In some embodiments, the audible items are the results of a search. When rendered with suitable conditioning, the items are presented to a user who can then filter the search results.

Some embodiments combine audible conditioning with visual avatars portrayed on, for example, a display screen of a user device. During the rendering, each audible item is paired with an avatar, the pairing based on some suitable criterion, such as a type of conditioning applied to the audible item. For example, an item rendered louder than others has a larger than normal avatar. An item that is rendered up-register is associated with a female (or child) avatar, while a down-register item is associated with a male avatar. Audible spatial placement is mimicked by visual placement of the avatars on the user's display screen. An avatar can move in synchrony with its audible item. In experiments, these avatars greatly help the user in distinguishing among the simultaneously rendered audible items.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIGS. 1a and 1b are simplified schematics of a personal communication device that supports filtering of a list of audible items according to aspects of the present invention;

FIG. 2 is a flowchart of an exemplary method for conditioning audible items so that they can be filtered by a user;

FIG. 3 is a dataflow diagram showing possibilities for conditioning audible items; and

FIG. 4 is a screen shot of an exemplary user interface.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

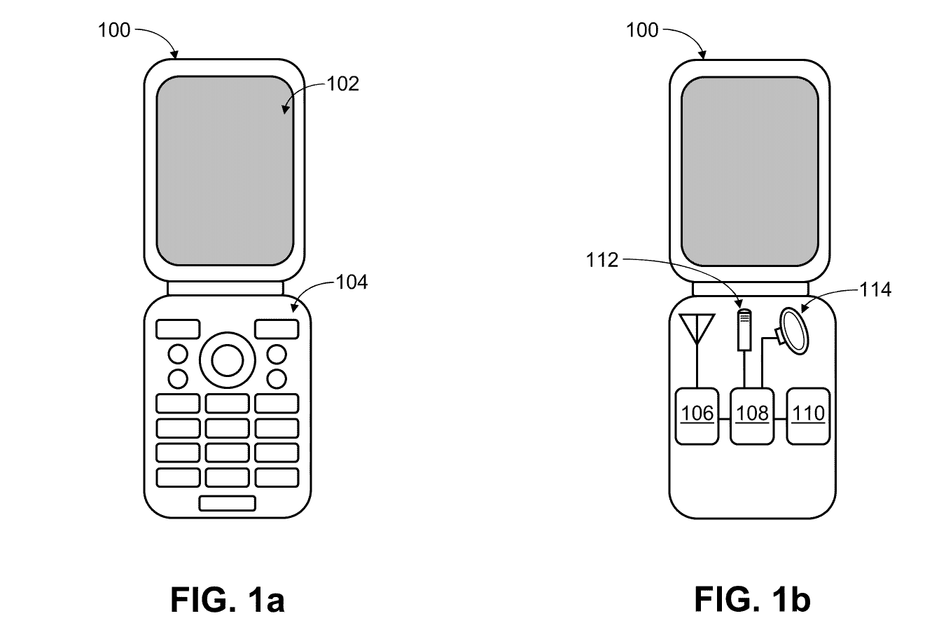

FIGS. 1a and 1b show a personal communication device 100 (e.g., a cellular telephone, personal digital assistant, or personal computer) that incorporates an embodiment of the present invention in order to filter a list of audible items. FIGS. 1a and 1b show the device 100 in an open configuration, presenting its main display screen 102 to a user. Typically, the main display 102 is used for most high-fidelity interactions with the user. For example, the main display 102 is used to show video or still images, is part of a user interface for changing configuration settings, and is used for viewing call logs and contact lists. To support these interactions, the main display 102 is of high resolution and is as large as can be comfortably accommodated in the device 100. A device 100 may have a second and possibly a third display screen for presenting status messages. These screens are generally smaller than the main display screen 102. They can be safely ignored for the remainder of the present discussion.

The typical user interface of the personal communication device 100 includes, in addition to the main display 102, a keypad 104 or other user-input devices.

FIG. 1b illustrates some of the more important internal components of the personal communication device 100. The device 100 includes a communications transceiver 106, a processor 108, and a memory 110. A microphone 112 (or two) and a speaker 114 are usually present.

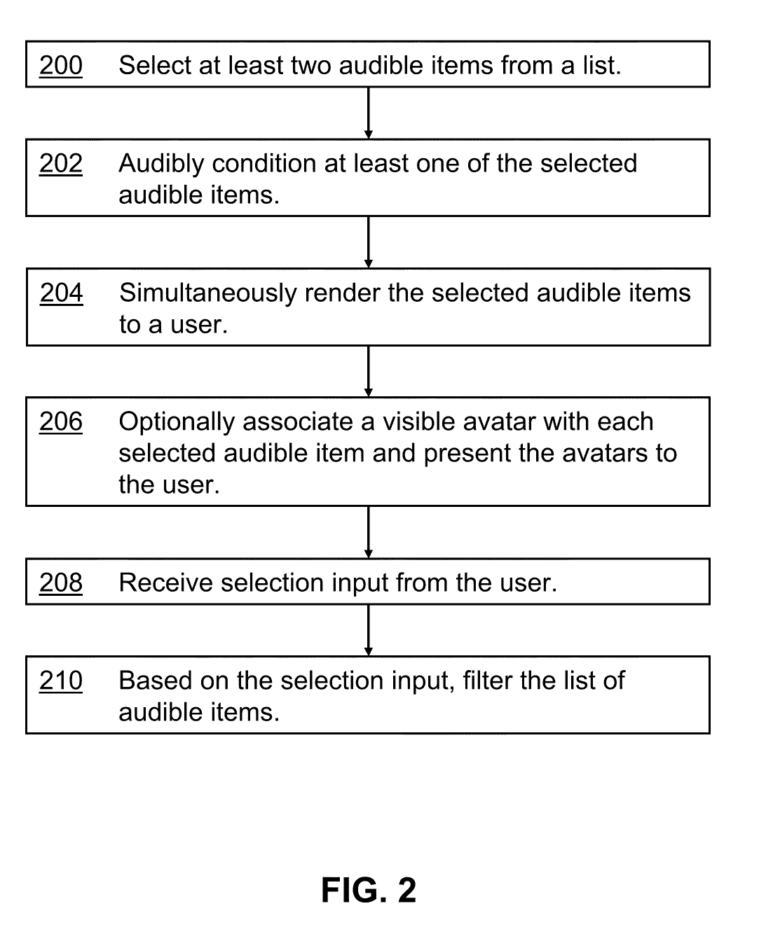

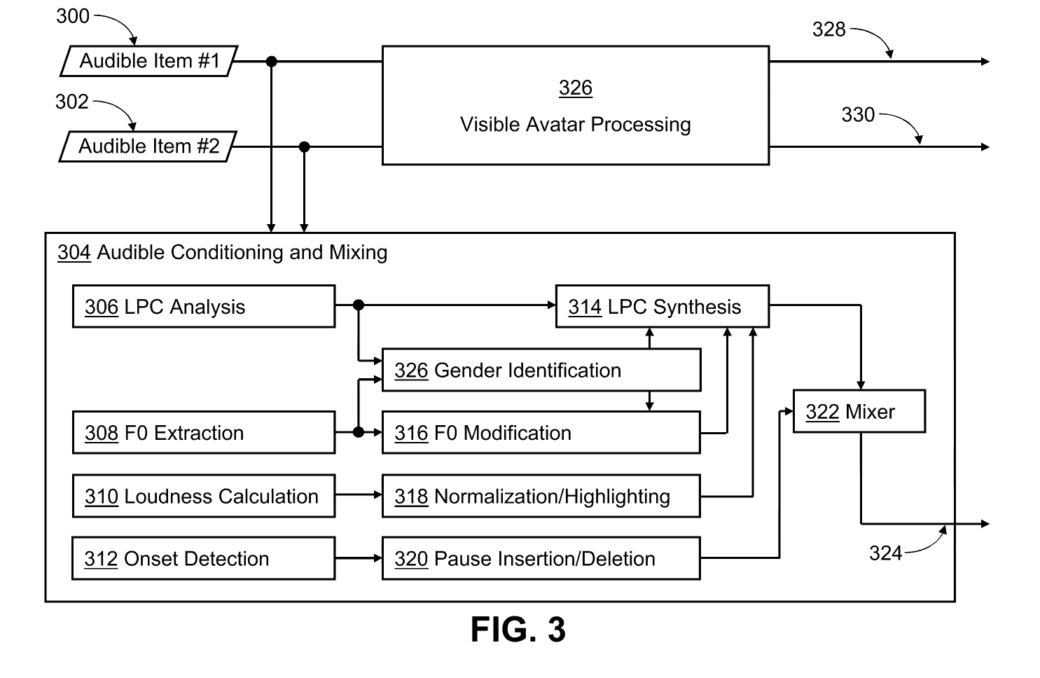

FIG. 2 presents an embodiment of the methods of the present invention. FIG. 3 shows how data flow through an embodiment of the present invention. These two figures are considered together in the following discussion.

Before the method of FIG. 2 begins, a list of audible items is prepared. This list can represent, for example, the results of a search or can be the contents of a song directory stored on the personal communication device 100. The method of FIG. 2 begins in step 200 by selecting at least two audible items from the list. The selected audible items are labeled 300 and 302 at the upper left side of FIG. 3.

The selected audible items 300, 302 will be simultaneously presented to the user (in step 204). To avoid cacophony, in step 202 at least one of these audible items 300, 302 is first conditioned. This conditioning serves to distinguish the audible items 300, 302 when they are heard together. The Audible Conditioning and Mixing process 304 of FIG. 3 presents several possibilities for audible conditioning. Well known LPC (Linear Predictive Coding) techniques can be used to analyze (306) the audible items 300, 302. Well known Pitch Synchronous Overlap techniques can also be used in some embodiments.

In some cases (especially when an audible item includes a human voice), it is useful to extract the pitch frequencies of the audible item (308) and then modify them (316). The resulting modified audible item can, for example, be moved up in register to sound as if it came from a female or from a child.

The loudness of an audible item can be calculated (310) and altered (318) to move the audible item around in the hearer's perceptual space. That is, the audible item can be made to seem to come from a source closer or farther away than the source of other audible items, or from the hearer's right or left side. If the list of audible items is the result of a spoken search query, then when the spoken search terms are detected in an audible item, they can be made louder (318) to emphasize them to the hearer.

The onset of voice in an audible item can be detected (312) and altered (320) by lengthening or shortening pauses. Thus two audible items are played simultaneously, but their voice components are offset making them more readily distinguishable by the hearer. Other known sound techniques can be applied in the Audible Conditioning and Mixing process 304.

After resynthesis (314), the conditioned (and possibly some unconditioned) audible items are mixed together (322), and the resultant audio output stream 324 is rendered on the speaker (114) of the personal communication device 100. (Step 204 of FIG. 2.)

In some embodiments, the Audible Conditioning and Mixing process 304 includes a special gender identification process 326. This process 326 reviews the LPC (306) and F0 (308) data in an attempt to identify a human voice (speaking or singing) in each audible item 300, 302. If a human voice is identified, then the gender of that voice is determined. Specific knowledge of the gender of a voice is useful both while conditioning the audible items to be presented (step 202 of FIG. 2) and while selecting audible items (step 208, discussed below).

In some embodiments, visual avatars are included along with the audio conditioning to help the user more readily distinguish among the audible items. Optional step 206 in FIG. 2 can occur synchronously with steps 202 and 204. In step 206, a visible avatar is associated with each audible item selected to be presented to the user.

In some embodiments, the avatars are still images that are easily associated by the user with a particular audible item. For example, one audible item can either be detected to include a female vocalization (326) or can be conditioned so that its vocalization sounds like it was produced by a female. The visible avatar can be a female face. The user easily associates the avatar with the audible item.

In more sophisticated embodiments, the avatar moves in response to its associated audible item. This is indicated in FIG. 3 by the Visible Avatar Processing process 326. For example, the avatar can “lip synch” vocalizations in an audible item, can dance to a beat in the audible item, or can display emotions detected in the audible item. The avatar's response can be exaggerated to allow the user to more easily associate the avatar with its audible item.

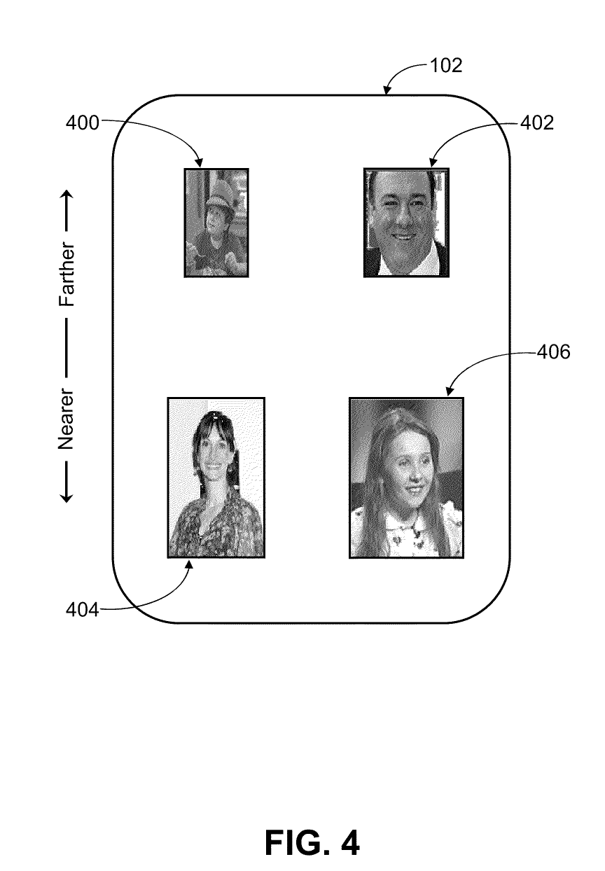

The size and position of the avatar can reflect the volume and spatial position of the audible item as conditioned in step 202 of FIG. 2. The visible output streams 328 and 330 (FIG. 3) of the avatars are presented on the display screen 102 of the user's personal communication device 100 in synchrony with the audio rendering of the audible items. An example of the avatars is discussed below in reference to FIG. 4.

With the audio conditioning and, optionally, the visible avatars, the user can now clearly distinguish among the simultaneously presented audible items. In step 208 of FIG. 2, the user provides some selection input to the personal communication device 100. For example, the user may end the selection process by choosing one audible item to hear by itself. The user may instead eliminate some (or all) of the presented audible items, have them replaced in the interface with others, and continue the selection process. The user can also refine a search by asking for more audible items that resemble (or that do not resemble) the audible items selected.

The user can choose among several techniques when selecting audible items. The user can speak a command such as “keep the woman, drop the others” or “switch the closeness of the near and far items.” When visible avatars are presented on the display screen 102, the user can select an audible item by selecting its associated avatar.

Regardless of how the user enters the selection input, that input is considered and the list of audible items is appropriately filtered in step 210.

FIG. 4 is an example visual interface supported by some embodiments of the present invention. The display screen 102 of the personal communication device 100 is shown displaying four avatars 400, 402, 404, and 406. Each avatar is associated with a, possibly conditioned, audible item. The four audible items are rendered simultaneously over the speaker 114 of the device 100. The audible items have been conditioned so that the two audible items associated with the avatars 400 and 402 sound farther away than the two audible items associated with the avatars 404 and 406, and this is reflected by the difference in size and position of these avatars. The audible item associated with avatar 402 is rendered in a man's vocal register (whether or not the original audible item was in that register), while the audible item associated with the avatar 404 is rendered in a woman's register. In some embodiments, audio spatial conditioning makes the audible items associated with avatars 400 and 404 sound like they are coming from the user's left, while the other two come from the user's right. In some embodiments, the avatars 400, 402, 404, and 406 are moving in synchrony with their associated audible items. With the audio conditioning and the visible avatars, the user is easily able to distinguish among the four simultaneously rendered audible items. (Tests have shown that four simultaneous items is a good number for many users.) Either through speech commands, or by selecting a visible avatar 400, 402, 404, 406 on the display screen 102, the user provides selection input to filter the list of audible items.

In view of the many possible embodiments to which the principles of the present invention may be applied, it should be recognized that the embodiments described herein with respect to the drawing figures are meant to be illustrative only and should not be taken as limiting the scope of the invention. For example, other known techniques of audio conditioning are available for distinguishing the simultaneously rendered audible items. Other arrangements of the avatars shown in the figures and the addition of other known visual techniques are possible and may be called for in various environments. Therefore, the invention as described herein contemplates all such embodiments as may come within the scope of the following claims and equivalents thereof.

We claim:

1. A method for filtering a list of a plurality of audible items, the method comprising:
selecting at least two audible items from the list;
audibly conditioning at least one of the selected audible items;
simultaneously rendering to a user the selected audible items, including the at least one audibly conditioned item;
receiving selection input from the user; and
filtering the list of the plurality of audible items, the filtering based, at least in part, on the selection input from the user.

2. The method of claim 1 wherein the plurality of audible items are the results of a search performed for the user.

3. The method of claim 2 wherein terms of the search are specified, at least in part, by audible input from the user.

4. The method of claim 1 wherein audibly conditioning an audible item comprises applying a technique selected from the group consisting of: changing a register of vocals in the audible item, changing an amplitude profile of the audible item, changing a perceptual spatial position of the audible item, changing an audible onset of the audible item.

5. The method of claim 1 wherein the selection input from the user comprises an element selected from the group consisting of: audible input, a keyboard input, and a touchscreen input.

6. The method of claim 1 further comprising:
for each selected audible item, associating a visible avatar with the audible item and rendering to the user the visible avatar.

7. The method of claim 6 wherein an avatar is associated with an audible item by using a technique selected from the group consisting of: matching a register of vocals in the audible item to an appearance of the avatar, matching a size or a position of the avatar with a perceptual spatial position of the audible item, matching a size or a position of the avatar with an amplitude profile of the audible item, and matching gestures of the avatar with vocals of the audible item.

8. The method of claim 7 wherein gestures of the avatar are selected from the group consisting of: lip movements, facial expressions, hand movements, and body gestures.

9. The method of claim 6 wherein the selection input from the user comprises a selection of an avatar associated with an audible item.

10. A personal communication device comprising:
a speaker; and
a processor configured to:
receive a list of a plurality of audible items;
select at least two audible items from the list;
audibly condition at least one of the selected audible items;
simultaneously render to the speaker the selected audible items, including the at least one audibly conditioned item;
receive selection input from user of the personal communication device; and
filter the list of the plurality of audible items, the filtering based, at least in part, on the selection input from the user.

11. The personal communication device of claim 10 wherein the plurality of audible items are the results of a search performed for the user.

12. The personal communication device of claim 11 further comprising:
a microphone;
wherein terms of the search are specified, at least in part, by audible input received via the microphone from the user.

13. The personal communication device of claim 10 further comprising:
a receiver for receiving the list of the plurality of audible items.

14. The personal communication device of claim 10 wherein audibly conditioning an audible item comprises applying a technique selected from the group consisting of: changing a register of vocals in the audible item, changing an amplitude profile of the audible item, changing a perceptual spatial position of the audible item, changing an audible onset of the audible item.

15. The personal communication device of claim 10 wherein the selection input from the user comprises an element selected from the group consisting of: audible input, a keyboard input, and a touchscreen input.

16. The personal communication device of claim 10 further comprising:
a display;
wherein the processor is further configured to:
for each selected audible item, associate a visible avatar with the audible item and render to the user the visible avatar on the display.

17. The personal communication device of claim 16 wherein an avatar is associated with an audible item by using a technique selected from the group consisting of:
matching a register of vocals in the audible item to an appearance of the avatar, matching a size or a position of the avatar with a perceptual spatial position of the audible item, matching a size or a position of the avatar with an amplitude profile of the audible item, and matching gestures of the avatar with vocals of the audible item.

18. The personal communication device of clam 17 wherein gestures of the avatar are selected from the group consisting of: lip movements, facial expressions, hand movements, and body gestures.

19. The personal communication device of claim 16 wherein the selection input from the user comprises a selection of an avatar associated with an audible item.
